(19) United States
(12) Patent Application Publication
(10) Pub. No.: US 2010/0302422 A1
(43) Pub. Date: Dec. 2, 2010

(54) SOLID-STATE IMAGING DEVICE, CAMERA, AND DRIVING METHOD FOR SOLID-STATE IMAGING DEVICE

(75) Inventor: Makoto IKUMA, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/787,606

(22) Filed: May 26, 2010

(30) Foreign Application Priority Data
May 29, 2009 (JP) 2009-131201

(51) Int. Cl. H04N 5/335

(52) U.S. Cl. 348/300; 348/E05.091

(57) ABSTRACT

A high image quality solid-state imaging device that reduces horizontal noise is provided. An embodiment of the solid-state imaging device of the present invention is a solid-state imaging device which reads a pixel signal from each of unit pixels selected on a row basis, including amplifying transistors each of which is arranged in a corresponding one of the unit pixels, first transistors each of which is arranged on a column basis and supplies bias current to one of the amplifying transistors corresponding to a selected row, an active transistor which generates a reference bias voltage, a bias signal line through which the reference bias voltage is supplied from the gate terminal of the active transistor to gate terminals of the first transistors; and a low-pass filter inserted to the bias signal line between the gate terminal of the active transistor and the gate terminals of the first transistors.

### BACKGROUND OF THE INVENTION

(1) Field of the Invention

The present invention relates to a solid-state imaging device widely used as image input device for video camera and digital still camera, a camera, and a driving method for the solid-state imaging device.

(2) Description of the Related Art

In the application of the conventional solid-state imaging device, solid-state imaging devices with a resolution of millions of pixels have been mainly used. In recent years, cell size of photoelectric conversion element has been reduced, and high-definition solid-state imaging device having resolution of 10 million or more pixels are mainly used in the market.

Along with the resent development of the higher-resolution solid-state imaging device, further noise reduction has been requested. Generally, the noise generated in a solid-state imaging device is roughly categorized into horizontal noise and vertical noise, depending on the type of noise.

The vertical noise is mostly caused by the Fixed Pattern Noise (FPN). Since the column where the noise is generated is fixed in each device, most of the noise can be removed through optimization per device using a correction technology such as the Digital Signal Processor (DSP) connected in a subsequent stage of the solid-state imaging device.

On the other hand, the horizontal noise is irregular and no particular row generating the noise is specified. Accordingly, no correction can be performed for each device, and reduction in its absolute amount is desirable.

In general, whereas the random noise is hard to visually recognize because it appears at random on the entire screen according to the normal distribution, the horizontal noise is easily recognized visually.

For this reason, more specifically, low noise which is approximately one tenth of the random noise is considered desirable for the horizontal noise. Patent Literature 1 (Japanese Unexamined Patent Application Publication No. 2006-128704) discloses a technology for reducing the horizontal noise without affecting the photocharacterization.

There are several possible causes for the horizontal noise, and one of them is a phenomenon in which a horizontal line appears on a region with a bright object on the screen.

Such a phenomenon occurs when the output signal from the normal pixel in the same row as the bright object becomes relatively smaller than the output signal from the normal signal above or below the row due to the bright object, resulting in the horizontal line on the screen.

FIG. 4 shows the conventional method. This conventional method aims to solve the problem. Regarding the load transistor ML in the readout circuit 250, the electric currents Ibias 1 and Ibias 2 flowing the column signal lines V201 and V202 flow in the same manner as the conventional example. Regarding the active transistor MF, having current and size larger than those of the load transistor ML accelerates and stabilizes the bias voltage Vbias, reducing the horizontal noise without affecting the photocharacterization.

### SUMMARY OF THE INVENTION

However, with the conventional technology disclosed in Patent Literature 1, it was difficult to satisfy the horizontal noise standard which has been set as a recent goal. More specifically, the problem is that the noise cannot be removed with the conventional method because the horizontal noise needs to be reduced to approximately 0.3 ele (tens of μV) which is approximately one tenth of the random noise. More specifically, there is a problem that the thermal noise and 1/f noise due to the device generated in the current source 251 and the active transistor MF cannot be removed with the conventional method, generating the horizontal noise.

The present invention has been conceived to solve the problems, and it is an object of the present invention to provide a high image-quality solid-state imaging device that reduces the visually recognizable horizontal noise, and to provide a camera and a driving method for the solid-state imaging device.

A solid-state imaging device for solving the above-described problem is a solid-state imaging device which has unit pixels arranged in rows and columns and reads a pixel signal from each of the unit pixels selected on a row basis, the solid-state imaging device including: amplifying transistors each of which is arranged in a corresponding one of the unit pixels and outputs the pixel signal; first transistors each of which is arranged on a column basis and supplies bias current to one of the amplifying transistors corresponding to a selected row; a second transistor, one of a source terminal and a drain terminal of which is short circuited with a gate terminal, which generates (i) a constant reference bias current through the source terminal and the drain terminal and (ii) a reference bias voltage at the gate terminal; a bias signal line through which the reference bias voltage is supplied from the gate terminal of the second transistor to gate terminals of the first transistors to mirror the bias current with respect to the reference bias current; and a low-pass filter inserted to the bias signal line between the gate terminal of the second transistor and the gate terminals of the first transistors.

With this structure, the low-pass filter removes high frequency noise generated in the second transistor which generates the reference bias current for the current mirror. That is, the high frequency noise is removed from the reference bias voltage transmitted to the gate terminals of the first transistors. With this, the effect of high frequency noise is reduced from the pixel signal output from the amplifying transistor, effectively reducing the horizontal noise. As a result, high-quality image can be obtained.

Here, the low-pass filter may include: a resistive element inserted to the bias signal line between the gate terminal of the second transistor and the gate terminals of the first transistors; and a capacitive element connected to an end of the resistive element on a side of the first transistors and to a ground line.

With this structure, the low-pass filter can be composed with a simple circuit including a resistive element and a capacitive element.

Here, the low-pass filter may further include a switching element connected to both ends of the resistive element.

With this structure, although switching on the switching element expands the low-pass bandwidth, the transient response speed can be accelerated. On the other hand, although switching off the switching element delays the transient response speed, it is possible to narrow down the low-pass bandwidth. Accordingly, when a subsequent circuit does not read the pixels signals output from the amplifying transistor, it is possible to accelerate the transient response speed by switching on the switching element. On the other hand, when the subsequent circuit reads the pixel signal and when it is necessary to reduce the noise, it is possible to improve the noise removal effect by switching off the switching element.

Here, each of the unit pixels may include: a photodiode which converts light to signal charge; a floating diffusion layer which holds the signal charge; a reset transistor which resets the signal charge in the floating diffusion layer; a transfer transistor which transfers the signal charge from the photodiode to the floating diffusion layer; and one of the amplifying transistors which outputs the pixel signal according to the signal charge held by the floating diffusion layer, and the switching element may be on during a first period and may be switched off when the first period ends, the first period being a period in which the resetting operation is performed by the reset transistor.

With this structure, it is possible to promptly stabilize transient variation in the reset level output from the amplifying transistor in the first period. Furthermore, it is possible to effectively remove the effect of the high frequency noise when reading the reset level by the subsequent stage after the first period.

Here, the switching element may be on during a second period and switched off when the second period ends, the second period being a period in which the transferring operation is performed by the transfer transistor.

With this structure, it is possible to promptly stabilize transient variation in the data level output from the amplifying transistor in the first period. Furthermore, it is possible to effectively remove the effect of the high frequency noise when reading the data level to the subsequent stage after the first period.

Here, the switching element may be on during a period when the pixel signals output from the amplifying transistors vary, and may be off during a period when the pixel signals output from the amplifying transistors are stable.

With this structure, the transient response speed can be accelerated by switching on the switching element in a period when the pixel signals vary to promptly stabilize the pixel signal. On the other hand, in a period when the pixel signals are stable, it is possible to improve the effect on noise removal upon readout of the pixel signals by the subsequent circuit.

Here, the capacitive element may be externally attached to an LSI chip of the solid-state imaging device.

This structure eliminates the limitation in the capacity of the capacitive element, allowing the capacitive element to be large, the resistive element to be small, reducing the chip area, and increasing the flexibility of the LSI chip layout design.

Furthermore, a camera and a driving method for the solid-state imaging device according to an aspect of the present invention include the structure similar to those described above.

The solid-state imaging device according to the present invention can effectively reduce the horizontal noise generated in the high resolution solid-state imaging device.

### FURTHER INFORMATION ABOUT TECHNICAL BACKGROUND TO THIS APPLICATION

The disclosure of Japanese Patent Application No. 2009-131201 filed on May 29, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a circuit diagram illustrating the structure of a solid-state imaging device according to an embodiment of the present invention that can reduce the horizontal noise;

FIG. 2 is a timing chart according to an embodiment of the present invention;

FIG. 3 is a circuit diagram illustrating a modification of a solid-state imaging device according to an embodiment of the present invention that can reduce the horizontal noise; and

FIG. 4 is a circuit diagram illustrating the structure of the solid-state imaging device according to the conventional technology.

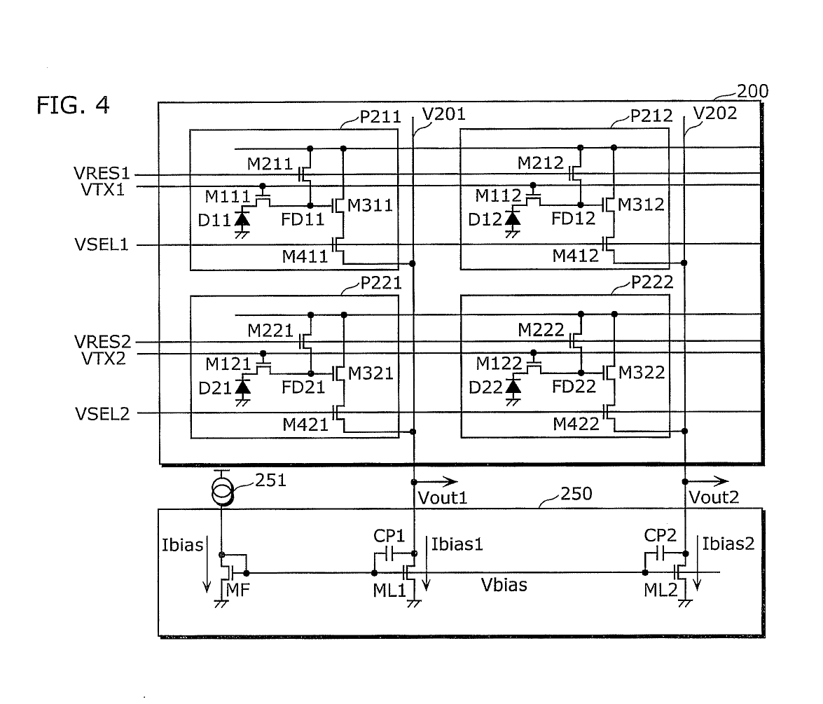

### DESCRIPTION OF THE PREFERRED EMBODIMENT(S)

The embodiment of the present invention shall be described as follows with reference to the drawings.

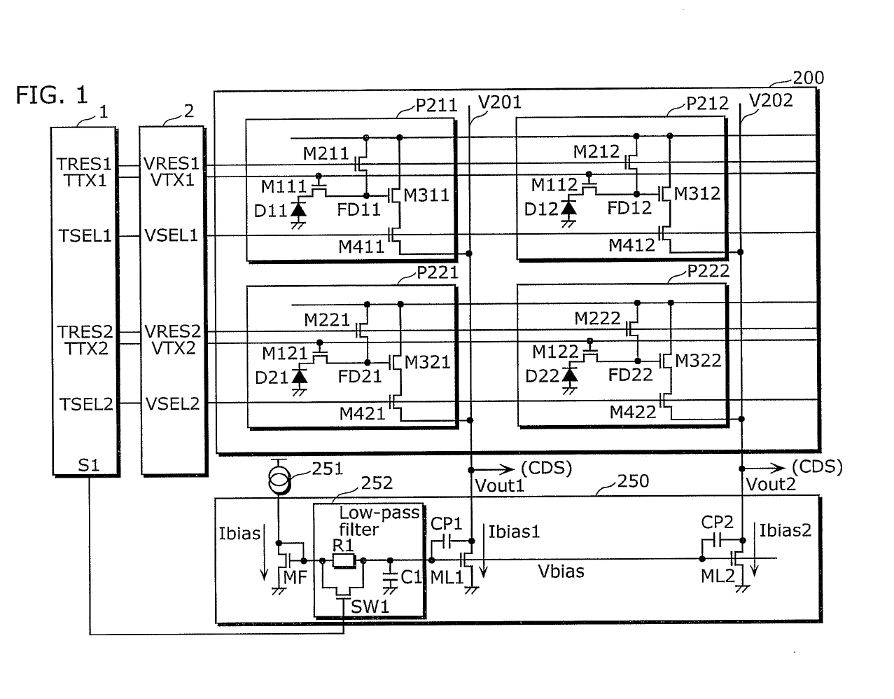

FIG. 1 is a circuit diagram indicating the structure of the solid-state imaging device according to the embodiment of the present invention.

As shown in FIG. 1, the solid-state imaging device includes a pixel array 200, a readout circuit 250, a timing generator 1, and a row scanning circuit 2. The pixel array 200 includes unit pixels P211 to P222 arranged in an m×n matrix. Here, a 2×2 pixel array is used for the simplicity of description. The readout circuit 250 is connected to the unit pixels P211 to P222 through column signal lines V201 and V202 for obtaining signals from the unit pixels P211 to P222.

In this structure, one Correlated Double Sampling unit which performs CDS per column is provided on the downstream side of the pixel array 200, and the output voltage Vout representing the pixel signal is inputted. When reading the pixel data, the solid-state imaging device simultaneously transmits the pixel signals from all of the pixels in the selected row of the pixel array 200 to the CDS circuits provided for each column at the same clock, and each CDS circuit sequentially transmits the obtained pixel signals to the subsequent stage.

The readout circuit 250 includes first transistors (hereinafter referred to as load transistors) ML1, ML2 that are provided in each column, a low-pass filter 252, and a second transistor (hereinafter referred to as active transistor) MF.

Each of the load transistors is arranged in each column, and which supplies bias current to an amplifying transistor belonging to the selected row. One load transistor and one amplifying transistor belonging to the selected row compose a source follower circuit.

One of the source terminal and drain terminal of the active transistor (drain terminal in FIG. 1) is short circuited with the gate terminal, and the one of the source terminal and the drain terminal (drain terminal in FIG. 1) is connected to the current source 251. The other one of the source terminal and the drain terminal (the source terminal in FIG. 1) is grounded. With this, the active transistor generates a constant reference bias current through the source terminal and the drain terminal, and generates a reference bias voltage at the gate terminal.

The bias signal line connects the gate terminal of the active transistor and the gate terminal of each load transistor. The bias signal line supplies the reference bias voltage from the gate terminal of the active transistor to the gate terminal of each load transistor. The active transistor and each load transistor compose current mirrors. The bias current of each load transistor with respect to the reference bias current is mirror current. The mirror ratio may be one to one, or any given ratio.

The low-pass filter 252 is inserted on the bias signal line between the gate terminal of the active transistor and the gate terminal of each load transistor. The low-pass filter 252 removes high frequency noise generated in the active transistor generating the reference bias current of the current mirror. With this, the effect of high frequency noise is reduced from the pixel signal output from the amplifying transistor, effectively reducing the horizontal noise.

An example structure of the low-pass filter 252 in FIG. 1 includes a resistive element R1 inserted on the bias signal line between the gate terminal of the active transistor and the gate terminal of the load transistor, and the capacitive element C1 connected to a load transistor side end of the resistive element R1 and the ground line.

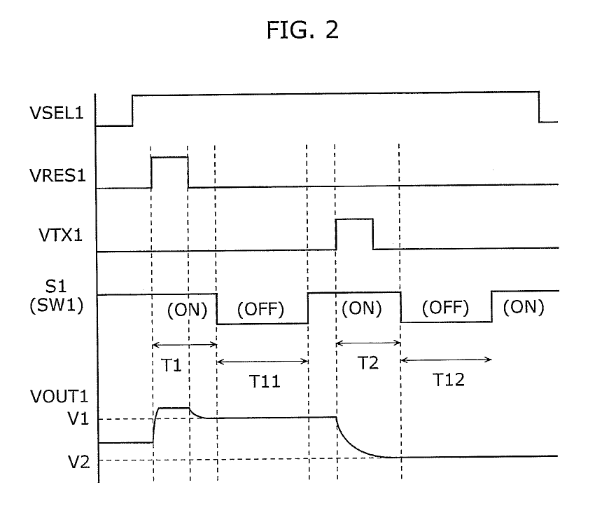

The low-pass filter 252 further includes a switching element SW1 connected to both ends of the resistive element R1. Switching on the switching element SW1 expands the low-pass bandwidth but accelerates a transient response speed. In contrast, switching off the switching element SW1 slows down the transient response speed but narrows down the low-pass bandwidth. The switching element is on in a period when the pixel signal outputted from the amplifying transistor to the column signal line varies (for example, T1, T2 in FIG. 2), and is off in a period when the pixel signal outputted from the amplifying transistor to the column signal line is stable (for example, T11, T12 in FIG. 2). The voltage level of the pixel signals in the column signal line (reset level or data level) is read to the CDS circuit in the stable period. With this, when the signal is not read to the CDS circuit, the transient response speed can be increased by switching on the switching element. On the other hand, when the signals are read to the CDS circuit and it is necessary to reduce the noise, switching off the switching element can increase the noise removal effect.

Furthermore, among the unit pixels P211 to P222, the unit pixel P211 includes one photodetector (also referred to as photodiode) D11 which receives the light and generate photoelectric charge and four MOS transistors M111, M211, M311, and M411, for example.

The four MOS transistors are, the transfer transistor M111 for transferring the photoelectric charge collected by the photodetector to a floating diffusion node (also referred to as a floating diffusion layer), a reset transistor M211 for setting a potential of the floating diffusion node at a desired value and resetting the potential of the floating diffusion node to a desired value to discharge the electric charge, an amplifying transistor M311 to which the voltage of the floating diffusion node is applied to the gate and which functions as a source follower buffer amplifier, and a select transistor M411 which specifies an address through switching.

Furthermore, the operations of the solid-state imaging device according to the embodiment of the present invention are described with reference to FIG. 1.

As shown in FIG. 1, the output signals of the timing generator 1, namely, the reset control signals TRES1 and 2, the transfer control signals TTX1 and 2, the select control signals TSEL1 to 2 are converted by the column scanning circuit 2 to voltage that is optimal for driving the reset transistor M211 to M222, the transfer transistor M111 to M122, and the select transistor M411 to M422, and then converted to reset control signals VRES 1 and 2, transfer control signals VTX 1 and 2, and select control signals VSEL 1 and 2, respectively. The signals are sequentially read out per row by vertical scanning from the column signal lines V201 and V202.

First, when the select control signal VSEL1 rises to high level switching on the select transistors M411 and M412 in the unit pixels, the first row is selected.

Next, while the transfer control signal VTX1 is in low level and the transfer transistors M111 and M112 are switched off, the reset control signal VRES1 rises to high level, switching on the reset transistors M211 and M212 and resetting the floating diffusion nodes FD11 and FD12 in the unit pixel 211 and 212.

Next, while the voltage of the floating diffusion nodes FD 11 and FD 12 is reset after a predetermined period of time, the reset control signal VRES falls into low level, switching off the reset transistors M211 and M212.

Subsequently, the voltage of the floating diffusion nodes FD 11 and FD 12 in the unit pixels 211 and 212 are amplified by the amplifying transistor M311 and M312, and the output voltages Vout1 and Vout2 are read out through the column signal lines V201 and V202 and stored as the reset value V1.

After a while, the transfer control signal VTX1 rises to high level. Switching on the transfer transistors M111 and M112 causes all of the photoelectric charge accumulated in the photodetectors D11 and D12 to be transmitted to the floating diffusion nodes FD11 and FD12. Subsequently, the transfer control signal VTX1 falls to low level, switching off the transfer transistors M111 to M112.

Subsequently, the output voltages Vout1 and Vout2 from the amplifying transistors M311 and M312 are read out through the column signal lines V201 and V202, and stored as the data value V2.

Next, the readout circuit 250 connected to the column signal lines V201 and V202 reads out the reset value V1 and the data value V2. The CDS circuit calculates the result value with respect to the data in the sampled pixels P211 to P222, using the voltage difference between the reset value V1 that was stored first and the data value V2 that was stored afterwards.

Next, when the second row is selected, the signals from the second row are read out as the output voltages Vout1 and Vout2 through the column signal lines V201 and V202 in the same manner.

The signals after the third row are sequentially read out in the same manner as the output voltages Vout1 and Vout2 through the column signal lines V201 and V202.

The readout circuit 250 includes load transistors ML1 and ML2 respectively connected to the column signal lines V201 and V202, and an active transistor MF composing current mirror circuits together with the load transistors ML1 and ML2. The load transistors ML1 and ML2 are provided for the respective columns, and the active transistor MF is provided such that each of the load transistors ML and the active transistor MF constitute a current mirror circuit.

In the above-described operation, the voltages of the photodetectors D11 to D22 are determined according to the intensity of the incident light. For example, the photodetector which received bright light generates a low voltage. On the other hand, the photodetector which received dark light generates a relatively high voltage.

As described above, the voltages in the floating diffusion nodes FD 11 to FD 22 is outputted by a source follower structures with the amplifier transistors M311 to M322 in the pixels in the selected row and the load transistors ML1 and ML2 composing the readout circuit 250. The output voltages Vout1 and Vout2 from the column signal lines V201 and V202 are determined based on the voltages in the floating diffusion nodes FD11 to FD22 on the selected row and the currents Ibias1 to Ibias2 flowing in the load transistors ML1 and ML2.

Here, the bias voltage Vbias determines the current Ibias in the active transistor MF in the readout circuit 250.

Here, the solid-state imaging device according to the embodiment of the present invention includes a low-pass filter 252 inserted between the gate of the active transistor MF to the gates of the load transistors ML1 to ML2 and a SW1 that is controlled by the bandwidth selection signal S1 and that can switch the bandwidth of the low-pass filter 252. The feature of the solid-state imaging device lies in shortening the convergence time by increasing the transient property through expanding the low-pass bandwidth when the output voltages Vout1 and Vout 2 of the column signal lines V201 and V202 are changing, narrowing down the low-pass bandwidth after the output voltages Vout1 and Vout2 are stabilized to improve the noise property.

Furthermore, the low-pass filter 252 is a circuit extracting only the low-frequency signals from the signals transmitted from the previous stage and transmitting the extracted signal to the subsequent stage, attenuating and removing the high frequency signals.

More specifically, the low-pass filter 252 transmits only the signal component in the low-frequency bandwidth including DC component in the signal component of the gate voltage of the active transistor MF, attenuates and removes the high frequency signal component. More specifically, while the DC voltage necessary for determining Ibias1 to Ibias2 is transmitted, the unnecessary high frequency voltage which would be noise is removed.

In the circuit structure of the low-pass filter 252, a simple primary RC filter composed of one resistor and one capacitance is selected as a typical example. When sharper attenuation property is necessary, the structure including secondary filter using operational amplifier may be used. In this case, excellent attenuation property is achieved.

Furthermore, regarding the circuit noise, each device such as transistor devices and resistive elements generates thermal noise which is white noise, and device noise such as 1/f noise dependent on the frequency is generated. The white noise is determined by a product of noise density and signal pass bandwidth. Accordingly, narrowing down the band pass width is considered as an option. On the other hand, as a measure to 1/f noise, expanding the size of the transistor in the circuit and raising the CDS sampling frequency are considered as options.

First, the current in the current source 251 is generally created by a constant voltage circuit and constant current circuit called bandgap reference circuit (BGR) in order to avoid the effect of variation in power source voltage and temperature fluctuation. Accordingly, the device noise is generated from each transistor element and resistive element.

Furthermore, the distance from the bandgap reference circuit (BGR) to the active transistor MF is often far in the layout. Thus, if the wiring in which Ibias flows and the wiring of the other digital signals are arranged in parallel or crossing each other, the digital noise is multiplexed on Ibias.

Furthermore, the device thermal noise of the active transistor MF and the device noise such as the 1/f noise are also added.

As a result, the current noise multiplexed on the current Ibias of the active transistor MF and the device noise of the active transistor MF are converted to the gate voltage of the active transistor MF.

The low-pass filter 252 implemented by the present invention transmits only the low frequency bandwidth voltage component including DC component, among the voltage component multiplexed on the gate of the active transistor MF, thereby reducing the noise in high frequency region. Accordingly, the voltages supplied to the gates of the load transistors ML1 and ML2 are transmitted with its high frequency noise reduced.

Next, the voltage noise multiplexed and reduced by the gate voltages of the load transistors ML1 and ML2 is converted to the current noise to be multiplexed on the currents Ibias1 to Ibias2, and finally, converted to the voltage noise by the amplifying transistor M311 to M322 on the selected row before multiplexed on the output voltages Vout1 to Vout2 on the column signal line. The voltage has reduced high frequency noise component.

Next, the readout circuit 250 connected to the column signal lines V201 to V202 simultaneously reads the entire signals in the pixels in the selected row as a reset value V1 and a data value V2 at the same clock. Subsequently, the CDS circuit calculates the signal levels of the unit pixels P211 to P222 using the voltage difference between the reset value V1 that was stored first and the data value V2 that was stored afterwards.

Thus, regarding 1/f noise in the frequency lower than the frequency of the CDS circuit (the time difference on reading out the reset value V1 and the data value V2), the voltage difference between the reset value V1 and the subsequently stored data value V2 becomes zero, and thus the noise can be removed by the CDS. However, other high frequency noise cannot be removed by the CDS, and the noise substantially same intensity as the frequency is multiplexed. As a result, the noise is likely to be visually seen as a horizontal noise.

Here, it is preferable that the low-pass bandwidth of the low-pass filter 252 is a frequency lower than the CDS frequency (the time difference on reading out the reset value V1 and the data value V2) for the above-described reason. The setting allows removal of the noise by the CDS even if the low-frequency noise such as the 1/f noise passes through. On the other hand, the high frequency noise such as thermal noise which is the white noise and is not removed by the CDS is reduced with the effect of the low-pass filter 252.

Furthermore, the bandwidth of the low-pass filter 252 is simply determined by the product of the capacitance value of the capacitive element C1 and the resistance value of the resistive element R1. Accordingly, even when attempting to have an identical bandwidth, many combinations of the capacitance value of the capacitive element C1 and the resistance value of the resistive element R1 are possible.

For example, mounting the capacitive element outside the chip without integration in the same chip allows a large value for the capacitive element C1, and thus the resistive element R1 may be small or at zero. This is because the active transistor MF functions equivalent to a resistive element. In this case, the delay in the convergence time of the bias voltage Vbias shown below does not occur. Thus, the horizontal noise can be effectively reduced.

On the other hand, when the capacitive element C1 cannot be implemented as an external capacitance and has to be integrated in the same chip, the value of the capacitive element C1 is relatively small. Thus, the resistance value in the resistive element R1 is large. Here, setting the passing band of the low-pass filter 252 to reduce the noise may cause the following problem.

More specifically, the overlapping capacitances Cp1 to Cp2 between the column signal lines V201 and V202 respectively connected to the drains of the load transistors ML1 and ML2 and the gates of the load transistors ML1 and ML2 and the resistive element R1 compose the high pass filter (HPF), and the larger the resistance value of the resistive element R1, the lower the cutoff frequency.

Accordingly, when the output voltages Vout1 and Vout2 from the column signal line V201 and V202 changes to the reset voltage V1, or when the data voltage V2 significantly change due to entrance of bright light, the bias voltage Vbias changes.

Here, the current of the current Ibias in the current source 251 attempts to supply the current to the line with Vbias such that the variation in Vbias is controlled. Alternatively, the active transistor MF attempts to obtain current from the line with Vbias such that the variation in Vbias is controlled.

However, the larger resistance value in the resistive element R1 restricts the amount of current, delaying the restoration time of the bias voltage Vbias.

Accordingly, the current values flowing the load transistors ML1 to ML2 significantly changes, delaying the convergence time, and the Vgs voltage generated by the amplifying transistors M321 and M322 in the selected row significantly changes. With this, the signal determined by the difference between the reset voltage V1 and the data voltage V2 is determined as a value different from the normal signal of the pixel, causing the horizontal noise.

Particularly, due to various limits, it is necessary to set the resistance value of the resistive element R1 relatively large when the capacitive element is incorporated and it is necessary to set the value of C1 relatively small. In order to solve the horizontal noise caused here, the signals are controlled as shown in the timing chart in FIG. 2.

The signals are related to the select control signal VSEL1 in the row output from the row scanning circuit 2 (the gate voltages of the select transistors M411 and M412), the reset control signal VRES1 (the gate voltages of the reset transistors M211 and M212), the transfer control signal VTX1 (the gate voltage of the transfer transistor M111 and M112), and the output voltage Vout1 from the column signal line V201. Here, the bandwidth selection signal S1 newly output from the timing generator 1 and the output voltage Vout1 from the column signal line V201 are further indicated.

The timing generator 1 is integrated into one chip with the solid-state imaging device in recent years, and thus it is easy to add or control the bandwidth selection signal S1.

The operation is further described. First, the select control signal VSEL1 rises to high level, switching on the select transistors M411 and M412 in the unit pixel. This selects the first row.

Next, with the transfer control signal VTX1 at low level and the transfer transistors M111 and M112 switched off, the reset control signal VRES1 rise to high level, switching on the reset transistors M211 and M212, and resetting the voltage of the floating diffusion nodes FD11 and FD12 in the unit pixels 211 and 212.

Next, with the voltages of the floating diffusion nodes FD 11 and FD 12 are reset after a predetermined period of time, the reset control signal VRES1 falls into low level, switching off the reset transistors M211 and M212.

Subsequently, the voltages of the floating diffusion nodes FD11 and FD12 are respectively amplified by the amplifying transistors M311 and M312. Subsequently, the output voltages Vout1 to Vout2 are read via the column signal lines V201 to V202 and stored as the reset value V1.

Here, the bandwidth selection signal S1 controlling the bandwidth of the low-pass filter 252 is output from the timing generator 1. In the first period (the period T1) when the reset control signal VRES1 is switched on/off and the output voltage Vout1 varies, the switch SW1 short-circuits the resistive element R1 which outputs high level and composing the low pass filter 252, expanding the low pass bandwidth, increasing the transient response, and preventing the variation of the bias voltage Vbias. As described above, the switch SW1 is on at least during the first period, and is switched off when the first period ends. In the first period which includes reset operation by the reset transistor M211 and others, and indicates a period when the output voltage VOUT1 of the column signal line V201 significantly varies.

More specifically, in the example in FIG. 2, the first period is a period when the pixel signals output from the amplifying transistors M311 to the column signal line through application of the reset control signal VRES1 to the reset transistor M211 and others.

After a while, after the signals are fully stabilized (after T1), the bandwidth selection signal S1 outputs low level, the resistive element R1 composing the low pass filter 252 is not short-circuited by the switch SW1. Accordingly, the low pass bandwidth is narrowed down, and the low-pass filter 252 functions as a low pass filter.

In this status, the high frequency noise component can be reduced. The output voltage Vout1 and Vout2 of the amplifying transistors M311 and M312 within the period T11 are read to the CDS circuit, and stored as the reset value V1. As described above, the output signal of the column signal lines V201 and V202 is read to the CDS circuit, S1 rises to high level again, and wide bandwidth can be selected.

After a while, the transfer control signal VTX1 rises to high level, and switching on the transfer transistors M111 and M112, all of the photoelectric charge accumulated in the photodetectors D11 and D12 is transmitted to the floating diffusion notes FD11 and FD12. Subsequently, the transfer control signal VTX1 falls to low level, switching off the transfer transistors M111 and M112.

Subsequently, the output voltages Vout1 and Vout2 from the amplifying transistors M311 and M312 are respectively read out through the column signal lines V201 and V202, and stored as the data value V2.

Here, in the same manner as the description above, the bandwidth selection signal S1 controlling the bandwidth of the low pass filter 252 is output from the timing generator 1, switching on the transfer control signal VTX1 and the output voltage Vout1 varies. Output is in high level and the switch SW1 short-circuits the resistive element R1 composing the low-pass filter 252, expanding the low-pass bandwidth, increasing the transient response, and prevent the bias voltage Vbias from varying. As described above, the switch SW1 is on at least during the second period, and is switched off when the second period ends. The second period is a period including transferring operation by the transfer transistor M111, and indicates a period when the output voltage VOUT1 of the column signal line V201 varies.

More specifically, in the example of FIG. 2, the second period is a period when the output VOUT1 from the amplifying transistor M311 and others varies due to the application of the transfer control signal VTX1 to the transfer transistor M111 and others.

After a while, after the signals are fully stabilized (after T2), the bandwidth selection signal S1 in low level is outputted, the resistive element R1 composing the low pass filter 252 is not short-circuited by the switch SW1. Accordingly, the low pass bandwidth is narrowed down, and functions as a low pass filter.

In this state, the noise component in high frequency can be reduced. The output voltages of the amplifying transistor M311 to M312 is read to the CDS circuit as the output voltages Vout1 and Vout2, and stored as the data value V2. As described above, the output signals from the column signal lines V201 and V202 are read, S1 rises to high level again, and wide bandwidth can be selected.

Next, the readout circuit 250 connected to the column signal lines V201 and V202 reads out the reset value V1 and the data value V2. The CDS circuit calculates the result value with respect to the data in the sampled pixels P211 to P222, using the voltage difference between the reset value V1 that was stored first and the data value V2 that was stored afterwards.

Next, when the second row is selected, the signals from the second row are read out as the output voltages Vout1 and Vout2 through the column signal lines V201 and V202 in the same manner.

The signals after the third row are sequentially read out in the same manner as the output voltages Vout1 and Vout2 through the column signal lines V201 and V202.

Subsequently, the data with respect to light output from the unit pixels P211 and P222 only is obtained by calculating the difference between the reset voltage V1 and the data voltage V2.

With this, in this embodiment, the gate voltage Vbias of the load transistor ML is accelerated and stabilized. Furthermore, it is possible to reduce the horizontal noise only when reading the signal because the noise component can be reduced when reading the signals.

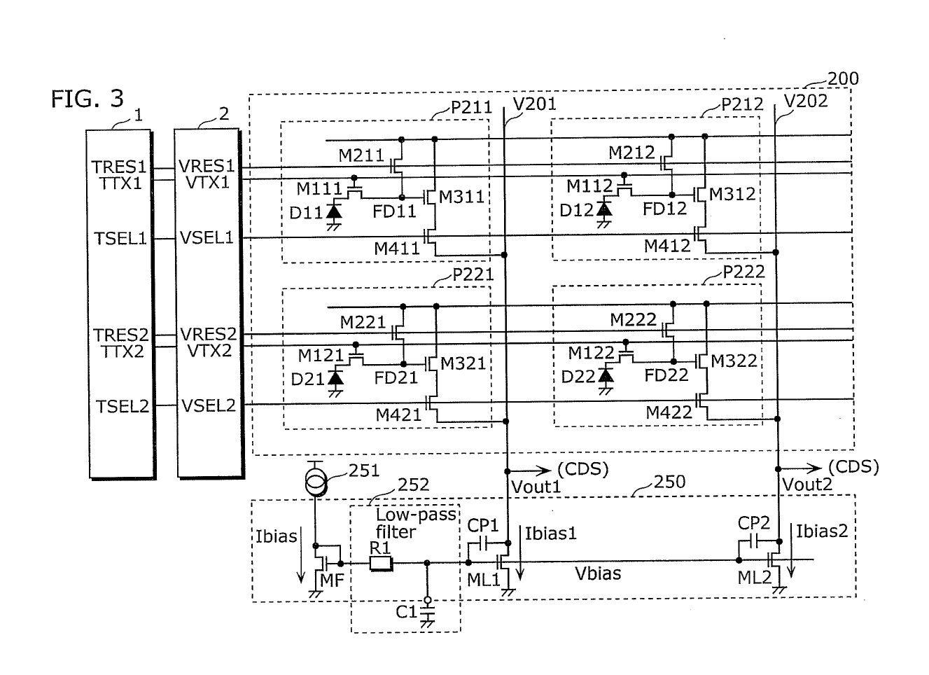

More specifically, the solid-state imaging device according to the embodiment of the present invention newly includes a low pass filter 252 inserted between the active transistor MF and the load transistors ML1 and ML2. Here, as shown in FIG. 3, the capacitive element C1 may be implemented as an external component attached outside the chip of the solid-state imaging device. In this case, the resistance value of the resistive element R1 may be small or at zero. This is because the active transistor MF functions equivalent to a resistive element. Here, the current noise generated in the current source 251 and multiplexed on the bias current Ibias and the device noise generated in the active transistor MF are converted to the voltage noise to be multiplexed on the bias voltage Vbias of the active transistor MF. Subsequently, among the voltage component, the high frequency noise is reduced by the low pass filter 252, and only the low frequency component including the DC component is transmitted to the gates of the load transistors ML1 and ML2. After that, the reduced voltage noise is converted to the current noise to be multiplexed on the bias current Ibias1 and Ibias2, is converted to the voltage noise by the amplifying transistors M311 to M322 on the selected row, and appears as noise in the output voltages Vout1 and Vout2 on the column signal lines V201 and V202. However, the value of the noise is reduced. In other words, the voltage multiplexed on the Vout1 and Vout2 from the column signal lines has reduced high frequency noise, and thereby reducing the generated amount of horizontal noise.

On the other hand, as shown in FIG. 1, when integrating the capacitive element C1 on the same chip, the value of the capacitive element C1 is relatively small. Accordingly, it is necessary to increase the resistance value of the resistive element R1. In this case, when the output voltages Vout1 and Vout2 from the column signal lines V201 and V202 vary, there are cases where the horizontal noise appears due to the delay in convergence of the bias voltage Vbias. In order to solve this problem, the low pass filter 252 includes the switch SW1 that can switch the bandwidth, expand the low pass bandwidth through the control of the bandwidth selection signal S1, increase the transient property when the vertical signals varies to increase, and accelerate the bias voltage Vbias, narrows down the low pass bandwidth to reduce the noise after the vertical signals are stabilized through the control of the bandwidth selection signals S1, and cause the output signals Vout 1 and 2 to be read to reduce the horizontal noise.

The present invention is applicable to all solid-state imaging devices including the readout circuit such as a CMOS solid-state imaging device.

Note that the pixel array 200 is composed of the 2×2 unit pixels P211 to P222 in the present invention. Needless to say, however, that the size is not limited to this example.

Note that the pixel array 200 is composed of one pixel-one cell structure in the present invention. Needless to say, however, the pixel array may have multiple pixel-one cell structure as well.

Furthermore, in the present invention, the low pass filter 252 is composed of one resistor and one capacitance. Needless to say, the structure including secondary filter using operational amplifier may be used, when sharper attenuation property is necessary.

Furthermore, in the present invention, the load transistors ML1 and ML2 that supplies Ibias1 and Ibias2 are connected to the column signal lines V201 and V202. Needless to say, however, the load transistors ML1 and ML2 may take a structure to suppress the variation in the gate voltages Vbias in the load transistors ML1 and ML2 by inserting cascode transistors between the load transistor ML1 and ML2 and the column signal lines V201 and V202, respectively, even when the output signals Vout1 and Vout2 from the column signal lines V201 and V202 significantly vary.

Although only an exemplary embodiment of the solid-state imaging device according to this invention has been described in detail above, those skilled in the art will readily appreciate that many modifications are possible in the exemplary embodiments without materially departing from the novel teachings and advantages of this invention. Accordingly, all such modifications are intended to be included within the scope of this invention. For example, a camera in which the solid-state imaging device according to the present invention is embedded is also included in the scope of the present invention.

### INDUSTRIAL APPLICABILITY

As described above, the present invention can reduce the horizontal noise with a simple structure requiring few elements, and is applicable to, for example, a CMOS solid-state imaging device, a digital still camera, a movie camera, a mobile phone with camera, and a monitoring camera and others.

What is claimed is:

1. A solid-state imaging device which has unit pixels arranged in rows and columns and reads a pixel signal from each of the unit pixels selected on a row basis, said solid-state imaging device comprising:
amplifying transistors each of which is arranged in a corresponding one of the unit pixels and outputs the pixel signal;
first transistors each of which is arranged on a column basis and supplies bias current to one of said amplifying transistors corresponding to a selected row;
a second transistor, one of a source terminal and a drain terminal of which is short circuited with a gate terminal, which generates (i) a constant reference bias current through the source terminal and the drain terminal and (ii) a reference bias voltage at the gate terminal;
a bias signal line through which the reference bias voltage is supplied from the gate terminal of said second transistor to gate terminals of said first transistors to mirror the bias current with respect to the reference bias current; and
a low-pass filter inserted to said bias signal line between the gate terminal of said second transistor and the gate terminals of said first transistors.

2. The solid-state imaging device according to claim 1,
wherein said low-pass filter includes:
a resistive element inserted to said bias signal line between the gate terminal of said second transistor and the gate terminals of said first transistors; and
a capacitive element connected to an end of said resistive element on a side of said first transistors and to a ground line.

3. The solid-state imaging device according to claim 2,
wherein said low-pass filter further includes
a switching element connected to both ends of said resistive element.

4. The solid-state imaging device according to claim 3,
wherein each of said unit pixels includes:
a photodiode which converts light to signal charge;
a floating diffusion layer which holds the signal charge;
a reset transistor which resets the signal charge in said floating diffusion layer;
a transfer transistor which transfers the signal charge from said photodiode to said floating diffusion layer; and
one of said amplifying transistors which outputs the pixel signal according to the signal charge held by said floating diffusion layer, and
said switching element is on during a first period and is switched off when the first period ends, the first period being a period in which the resetting operation is performed by said reset transistor.

5. The solid-state imaging device according to claim 4,
wherein said switching element is on during a second period and switched off when the second period ends, the second period being a period in which the transferring operation is performed by said transfer transistor.

6. The solid-state imaging device according to claim 3,
wherein said switching element is on during a period when the pixel signals output from said amplifying transistors vary, and is off during a period when the pixel signals output from said amplifying transistors are stable.

7. The solid-state imaging device according to claim 2,
wherein said capacitive element is externally attached to an LSI chip of said solid-state imaging device.

8. A camera comprising
said solid-state imaging device according to claim 1.

9. A driving method for a solid-state imaging device which has unit pixels arranged in rows and columns and reads a pixel signal from each of the unit pixels selected on a row basis,
wherein the solid-state imaging device includes:
amplifying transistors each of which is arranged in a corresponding one of the unit pixels and outputs the pixel signal;
first transistors each of which is arranged on a column basis and supplies bias current to one of the amplifying transistors corresponding to a selected row;
a second transistor, one of a source terminal and a drain terminal of which is short circuited with a gate terminal, which generates (i) a constant reference bias current through the source terminal and the drain terminal and (ii) a reference bias voltage at the gate terminal;
a bias signal line through which the reference bias voltage is supplied from the gate terminal of the second transistor to gate terminals of the first transistors to mirror the bias current with respect to the reference bias current; and
a low-pass filter inserted to the bias signal line between the gate terminal of the second transistor and the gate terminals of the first transistors, and
each of said unit pixels includes:
a photodiode which converts light to signal charge;
a floating diffusion layer which holds the signal charge;
a reset transistor which resets the signal charge in said floating diffusion layer;
a transfer transistor which transfers the signal charge from said photodiode to said floating diffusion layer; and
one of said amplifying transistors which outputs the pixel signal according to the signal charge held by said floating diffusion layer,
said driving method for the solid-state imaging device comprises:
switching on the switching element during a first period, and
switching off the switching element when the first period ends, the first period being a period in which the resetting operation is performed by the reset transistor.
